(19) United States
(12) Patent Application Publication
(10) Pub. No.: US 2023/0019353 A1
(43) Pub. Date: Jan. 19, 2023

(54) DOUBLE ROW TAPERED BEARING WITH PRESS FIT PRELOADING ELEMENTS

(71) Applicant: Sandcraft LLC, Phoenix, AZ (US)

(72) Inventors: Brent G. Reynolds, Peoria, AZ (US); Jonathan D. Roberts, Peoria, AZ (US); Jordan Hooper, Queen Creek, AZ (US)

(21) Appl. No.: 17/946,989

(22) Filed: Sep. 16, 2022

Related U.S. Application Data
(63) Continuation-in-part of application No. 17/516,445, filed on Nov. 1, 2021.
Application No. 17/516,445 is a continuation of application No. 17/146,398, filed on Jan. 11, 2021, now Pat. No. 11,162,529.
(60) Provisional application No. 62/959,759, filed on Jan. 10, 2020.

(51) Int. Cl. F16C 19/38; F16C 35/073; F16C 33/80; B60B 27/00; F16C 33/78; F16C 19/54

(52) U.S. Cl. CPC F16C 19/385; F16C 35/073; F16C 33/80; B60B 27/0073; F16C 33/7886; F16C 33/783; F16C 19/386; F16C 19/548; F16C 2326/02; F16C 33/7813

(57) ABSTRACT

A wheel bearing assembly with an outer race, a first roller bearing, a second roller bearing, a first shield, and a second shield. The outer race may have a first inner surface and a second inner surface. The first roller bearing and the second roller bearing may have a plurality of rollers configured to engage with the first inner surface and with the second inner surface, respectively. The first shield and the second shield may be configured to engage with the first roller bearing and the second roller bearing, respectively, and push the first roller bearing and the second roller bearing against the first inner surface and the second inner surface, respectively. The first shield and the second shield may each have a rubber seal configured to reduce passage of fluid into or out of the first roller bearing and the second roller bearing, respectively.

### RELATED APPLICATIONS

This application is a continuation-in-part application of U.S. patent application Ser. No. 17/516,445, filed on Nov. 1, 2021, titled “Double Row Tapered Bearing with Press Fit Preloading Elements,” which application is a continuation of U.S. patent application Ser. No. 17/146,398, filed on Jan. 11, 2021 and issued as U.S. Pat. No. 11,162,529 on Nov. 2, 2021, titled “Double Row Tapered Bearing with Press Fit Preloading Elements,” which claims priority to, and the benefit of, U.S. Provisional Patent Application No. 62/959,759, filed Jan. 10, 2020, titled “Double Row Tapered Bearing with Press Fit Preloading Elements,” the entirety of the disclosures of which are hereby incorporated by this reference.

### TECHNICAL FIELD

The present disclosure relates to bearings generally, and to roller bearings, and to bearings with press fit preloading elements, such as tapered bearings and double row tapered bearings. The present disclosure also relates to relates preventing contamination from entering wheel bearings.

### BACKGROUND

A ball bearing is a type of rolling-element bearing that uses balls or spheres disposed between concentric rings or bearing races (such as an inner race and an outer race) to maintain the separation between the races. The balls or rolling-elements provide for relative movement between the concentric (inner and outer) races to support radial and axial loads while reducing rotational friction between the races by the rolling or rotation of the balls. The rolling or rotation of the balls provides for a lower coefficient of friction than if the two races were to rotate by sliding against each other.

Another type of bearing is a roller bearing. Roller bearings differ from ball bearings by using elongated rollers, rather than a ball or sphere, as the rotational element or feature between the inner race and the outer race. As such, the shape or area of contact between the rollers and the races in the roller bearing is straight line or elongated contact point, rather than a point or non-elongated contact area, present as the point of contact with a ball or sphere.

A roller bearing may comprise cylindrically shaped rollers, and in other instances, may also comprise frustoconically shaped rollers to form a tapered roller bearing. In a tapered roller bearing the rollers may be formed as tapered cylinders to simultaneously support axial loads, radial loads, and thrust loads.

### SUMMARY

Aspects of this document relate to a wheel bearing assembly comprising an inner race having a center portion extending between a first end and a second end, an outer race disposed around the inner race, the outer race having a first angled inner surface and a second angled inner surface, wherein the first angled inner surface and the second angled inner surface form a peak, a first roller bearing positioned between the inner race and the outer race, the first roller bearing having a plurality of rollers configured to engage with the first angled inner surface of the outer race, a second roller bearing positioned between the inner race and the outer race and adjacent the first roller bearing, the second roller bearing having a plurality of rollers configured to engage with the second angled inner surface of the outer race, a first shield configured to engage with an outer edge of the first roller bearing and push the first roller bearing against the first angled inner surface of the outer race, the first shield comprising a rubber seal configured to reduce passage of fluid into or out of the first roller bearing, and a second shield configured to engage with an outer edge of the second roller bearing and push the second roller bearing against the second angled inner surface of the outer race, the second shield comprising a rubber seal configured to reduce passage of fluid into or out of the second roller bearing.

Particular embodiments may comprise one or more of the following features. The seal of the first shield and the seal of the second shield may each contact the outer race. The first end and the second end may each have a stepped surface with a first inner diameter and the center portion may have a second inner diameter, wherein the first inner diameter is greater than the second inner diameter. The first shield may further comprise a guiding lip configured to engage with the stepped surface of the first end of the inner race. The inner race may comprise two pieces that together form the center portion extending between the first end and the second end. Each of the two pieces may comprise a stepped surface configured to interlock with the stepped surface of the other of the two pieces. The wheel bearing assembly may further comprise a seal positioned on an inner surface of the inner race, wherein the seal is configured to seal with a shaft when the shaft extends through wheel bearing assembly. The wheel bearing assembly may further comprise a pinch nut configured to create and maintain a desired preload on the wheel bearing assembly.

Aspects of this document relate to a wheel bearing assembly comprising an outer race having a first angled inner surface and a second angled inner surface, wherein the first angled inner surface and the second angled inner surface form a peak, a first roller bearing positioned within the outer race, the first roller bearing having a plurality of rollers configured to engage with the first angled inner surface of the outer race, a second roller bearing positioned within the outer race adjacent the first roller bearing, the second roller bearing having a plurality of rollers configured to engage with the second angled inner surface of the outer race, a first shield configured to engage with an outer edge of the first roller bearing and push the first roller bearing against the first angled inner surface of the outer race, the first shield comprising a rubber seal configured to reduce passage of fluid into or out of the first roller bearing, and a second shield configured to engage with an outer edge of the second roller bearing and push the second roller bearing against the second angled inner surface of the outer race, the second shield comprising a rubber seal configured to reduce passage of fluid into or out of the second roller bearing.

Particular embodiments may comprise one or more of the following features. The seal of the first shield and the seal of the second shield may each contact the outer race. The wheel bearing assembly may further comprise an inner race positioned within the outer race such that the first roller bearing and the second roller bearing are each positioned between the inner race and the outer race. The inner race may comprise two pieces. Each of the two pieces may comprise a stepped surface configured to interlock with the stepped surface of the other of the two pieces. The inner race may have a center portion extending between a first end and a second end, wherein the first end and the second end each have a stepped surface with a first inner diameter and the center portion has a second inner diameter, wherein the first inner diameter is greater than the second inner diameter. The first shield may further comprise a guiding lip configured to engage with the stepped surface of the first end of the inner race. The wheel bearing assembly may further comprise a seal positioned on an inner surface of the inner race, wherein the seal is configured to seal with a shaft when the shaft extends through wheel bearing assembly. The wheel bearing assembly may further comprise a pinch nut configured to create and maintain a desired preload on the wheel bearing assembly.

Aspects of this document relate to a wheel bearing assembly comprising a race having a first surface and a second surface, a first roller bearing having a plurality of rollers configured to engage with the first surface of the race, a second roller bearing having a plurality of rollers configured to engage with the second surface of the race, a first shield configured to engage with an edge of the first roller bearing and push the first roller bearing against the first surface of the race, the first shield comprising a seal configured to reduce passage of fluid into or out of the first roller bearing, and a second shield configured to engage with an edge of the second roller bearing and push the second roller bearing against the second surface of the race, the second shield comprising a seal configured to reduce passage of fluid into or out of the second roller bearing.

Particular embodiments may comprise one or more of the following features. The seal of the first shield and the seal of the second shield may each contact the race. The seal of the first shield and the seal of the second shield may each comprise a rubber material or a steel material. The race may be an outer race and the wheel bearing assembly may further comprise an inner race positioned within the outer race such that the first roller bearing and the second roller bearing are each positioned between the inner race and the outer race. The inner race may comprise two pieces. Each of the two pieces may comprise a stepped surface configured to interlock with the stepped surface of the other of the two pieces. The inner race may have a center portion extending between a first end and a second end, wherein the first end and the second end each have a stepped surface with a first inner diameter and the center portion has a second inner diameter, wherein the first inner diameter is greater than the second inner diameter. The first shield may further comprise a guiding lip configured to engage with the stepped surface of the first end of the inner race. The wheel bearing assembly may further comprise a seal positioned on an inner surface of the inner race, wherein the seal is configured to seal with a shaft when the shaft extends through wheel bearing assembly. The wheel bearing assembly may further comprise a pinch nut configured to create and maintain a desired preload on the wheel bearing assembly.

Aspects of this document relate generally to a wheel bearing, a double row tapered bearing with press fit preloading elements, an assembly therefore, or methods relating to the same. These aspects may comprise, and implementations may include, one or more or all of the components, steps, or both, set forth in the appended claims. In a general aspect, a wheel bearing assembly, or a UTV double row tapered wheel bearing assembly, may include an inner sleeve comprising an outer radial surface and a radially aligned circular ridge disposed at the outer radial surface configured to separate a first inner race and a second inner race. A first inner diameter race may be disposed around a first portion of the outer radial surface of the inner sleeve. A second inner diameter race may be disposed around a second portion of the outer radial surface of the inner sleeve. An outer diameter race may be radially offset from the first inner diameter race and the second inner diameter race, the outer diameter race may comprise an outer flat radial surface and an inner tapered radial surface opposite the outer flat radial surface. The outer diameter race may be formed as a single integral member, wherein outer axial surfaces of the outer diameter race overhang the outer axial surfaces of the first inner diameter race and the second inner diameter race. A first ring of rollers may be disposed between the outer diameter race and the first inner diameter race, wherein the first ring of rollers comprises rollers that are frustoconically shaped. A second ring of rollers may be disposed between the outer diameter race and the second inner diameter race offset from the first ring of rollers, wherein the second ring of rollers comprises rollers that are frustoconically shaped. A first shield may be coupled to a first axial face of the bearing configured to seal the interior of the bearing, the first ring of rollers, and the second ring of rollers from external contaminates. A second shield may be coupled to the second axial face of the bearing and configured to seal the interior of the bearing, the first ring of rollers, and the second ring of rollers from external contaminates.

In some aspects, the wheel bearing assembly may include the first shield and the second shield comprising seals that contact the inner radial surface of the outer race. The first shield may be press fit on the first inner diameter race and further seal with a stepped surface of the inner sleeve. The outer axial surfaces of the outer diameter race may overhang outer axial surfaces of the inner sleeve. The preload to the wheel bearing may be applied through tightening a nut to 40-180 ft-lbs of torque. The preload to the wheel bearing may be applied through tightening a nut to 10-180 ft-lbs of torque. A method of installing the UTV double row tapered wheel bearing assembly may comprise tightening a nut on a wheel shaft to press the bearing against the snap ring by applying 80-140 ft-lbs of torque, or 5-140 ft-lbs of torque, to the nut, wherein the force of the nut tightening on the wheel shaft presses the first shield against the inner diameter race. The inner diameter race may press against the first ring of rollers, and the first ring of rollers may press against the outer diameter race, and the first ring of rollers may move towards a circular ridge of the inner sleeve.

In some aspects, a wheel bearing assembly, or a UTV double row tapered wheel bearing assembly, may include an inner sleeve comprising an outer radial surface, a first inner diameter race disposed around a first portion of the outer radial surface of the inner sleeve, and a second inner diameter race disposed around a second portion of the outer radial surface of the inner sleeve. An outer diameter race may be radially offset from the first inner diameter race and the second inner diameter race. The outer diameter race may comprise an outer flat radial surface and an inner tapered radial surface opposite the outer flat radial surface. The outer diameter race may be formed as a single integral member. A first ring of rollers may be disposed between the outer diameter race and the first inner diameter race. A second ring of rollers may be disposed between the outer diameter race and the second inner diameter race offset from the first ring of rollers. A first shield may be coupled to a first axial face of the bearing, and a second shield may be coupled to the second axial face of the bearing.

In some further aspects, the wheel bearing assembly may further include the inner sleeve comprising a radially aligned circular ridge that separates the first inner race and the second inner race. The first shield and the second shield may be configured to seal the interior of the bearing and the first ring of rollers and the second ring of rollers from external contaminates. The first shield and the second shield may comprise seals that contact the inner radial surface of the outer race. Outer axial surfaces of the outer diameter race may overhang outer axial surfaces of the first inner diameter race and the second inner diameter race. The first shield may be press fit on the first inner diameter race and further seal with a stepped surface of the inner sleeve. The preload to the wheel bearing may be applied through tightening a nut to 40-180 ft-lbs of torque. The preload to the wheel bearing may be applied through tightening a nut to 5-180 ft-lbs of torque. The rollers of the first ring of rollers and of the second ring of rollers may be frustoconically shaped. A method of installing the UTV double row tapered wheel bearing assembly may comprise tightening a nut on a wheel shaft to press the bearing against the snap ring by applying 80-140 ft-lbs of torque, or 5-140 ft-lbs of torque to the nut. The force of the nut tightening on the wheel shaft may press the first shield against the inner diameter race, the inner diameter race may press against the first ring of rollers, and the first ring of rollers may press against the outer diameter race, and the first ring of rollers may moves towards a circular ridge of the inner sleeve.

In some aspects, a wheel bearing assembly, or a UTV double row tapered wheel bearing assembly, may include a first inner diameter race, a second inner diameter race axially offset from the first inner diameter race, and an outer diameter race radially offset from the first inner diameter race and the second inner diameter race. The outer diameter race may be formed as a single integral member. A first ring of rollers may be disposed between the outer diameter race and the first inner diameter race. A second ring of rollers may be disposed between the outer diameter race and the second inner diameter race. A first shield may be coupled to a first axial face of the bearing. A second shield may be coupled to the second axial face of the bearing.

In some further aspects, the wheel bearing assembly may further include an outer axial surfaces of the outer diameter race overhanging outer axial surfaces of the first inner diameter race and the second inner diameter race. The first shield and the second shield may comprise seals that contact the inner radial surface of the outer race. The first shield may be press fit on the first inner diameter race and further seals with a stepped surface of an inner sleeve. Preload to the wheel bearing may be in a range of 40-180 ft-lbs or torque. A method of installing the UTV double row tapered wheel bearing assembly may comprise tightening a nut on a wheel shaft 80-140 ft-lbs of torque. The force may press the first shield against the inner diameter race, the inner diameter race may press against the first ring of rollers, and the first ring of rollers may press against the outer diameter race.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

Unless specifically noted, it is intended that the words and phrases in the specification and the claims be given their plain, ordinary, and accustomed meaning to those of ordinary skill in the applicable arts. The inventors are fully aware that he can be his own lexicographer if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those of ordinary skill in the art from the specification, drawings, and the claims.

### BRIEF DESCRIPTION OF THE DRAWINGS

Implementations will hereinafter be described in conjunction with the appended drawings, where like designations denote like elements. Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations.

FIG. 1A depicts, according to an aspect, an exploded perspective view of a sealed double row tapered roller bearing with inner diameter shields and outer diameter shields.

FIG. 1B depicts a non-exploded perspective view of the sealed double row tapered roller bearing of FIG. 1A.

FIG. 1C depicts a broken away perspective view of a carrier bearing wheel assembly.

FIGS. 2A-2C depict various views of the sealed double row tapered roller bearing of FIGS. 1A and 1B.

FIGS. 3A-3C depict various views of a sealed double row tapered roller bearing of according to another aspect.

FIGS. 4A and 4B depict views of a UTV rear suspension elements compatible with improved UTV performance resulting from use of a sealed double row tapered roller wheel bearing.

FIGS. 5A and 5B depict views of a UTV rear wheel elements compatible with improved UTV performance resulting from use of a sealed double row tapered roller wheel bearing.

FIG. 6 depicts views of UTV rear wheel drive train elements and a wheel shaft for coupling with improved UTV performance resulting from use of a sealed double row tapered roller wheel bearing.

FIGS. 7A-7C depict views of a sealed double row tapered roller bearing according to another aspect.

FIGS. 8A-8C depict views of a sealed double row tapered roller bearing with interlocking inner races.

FIGS. 9A-9E depict cross-section views of variations of the sealed double row tapered roller bearing.

FIG. 10A-10D depict a pinch nut for use with the sealed double row tapered roller bearing.

### DETAILED DESCRIPTION

This disclosure, its aspects and implementations, are not limited to the specific structures, arrangements, material types, components, methods, or other examples disclosed herein. Many additional structures, arrangements, material types, components, methods, and procedures known in the art are contemplated for use with particular implementations from this disclosure. Accordingly, although particular implementations are disclosed, such implementations and implementing components may comprise any components, models, types, materials, versions, quantities, and/or the like as is known in the art for such systems and implementing components, consistent with the intended operation.

The words “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes embodiments of many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated. There are many features of a tapered press fit bearing and method implementations disclosed herein, of which one, a plurality, or all features or steps may be used in any particular implementation.

All amounts that are “about” or “substantially” equal to a given amount number, range, value, or quantity (hereinafter collectively “amount”) include both the amount and may include any amount within a range of +/−0-50%, 0-40%, 0-30%, 0-20%, 0-10%, and 0-5%. The articles “a”, “an”, and “the” each refer to one or more than one, unless otherwise indicated by the context of the specification. The disclosure of ranges includes the range itself and also anything subsumed therein, as well as endpoints. For example, disclosure of a range of 2.0 to 4.0 includes not only the range of 2.0 to 4.0, but also 2.1, 2.3, 3.4, 3.5, and 4.0 individually, as well as any other number subsumed in the range. Furthermore, disclosure of a range of, for example, 2.0 to 4.0 includes the subsets of, for example, 2.1 to 3.5, 2.3 to 3.4, 2.6 to 3.7, and 3.8 to 4.0, as well as any other subset subsumed in the range. Similarly, the disclosure of Markush groups includes the entire group and also any individual members and subgroups subsumed therein.

This disclosure, its aspects and implementations, are directed to an assembly for double row tapered bearings, tapered bearings, double row bearings, keeping contaminants from degrading bearings, and methods for using, arranging, or preloading the same. Double row tapered bearings and double row angular bearings are bearings with inner races or rings (hereinafter referred to as races) and outer races, which instead of having a single row of ball bearings or roller bearings, have a double row of cylindrical rollers (angular) or a double row of slightly conical (tapered) rollers. Tapered roller bearings are designed to withstand greater radial and thrust loads than ball bearings.

In the past, double row bearings have been formed with two sets of rollers that are held in place by two corresponding spacers/cages for separating the rollers. The two sets of rollers are sandwiched between a single integrally formed outer race and a single integrally formed inner race. The position between the upper and lower races is fixed, with the position of the rollers and spacers also being fixed relative to the inner and outer races so that an amount of contact/pressure/friction which is known as “preload” between the moving parts of the bearing (i.e. inner race, rollers, and outer race) is fixed or constant.

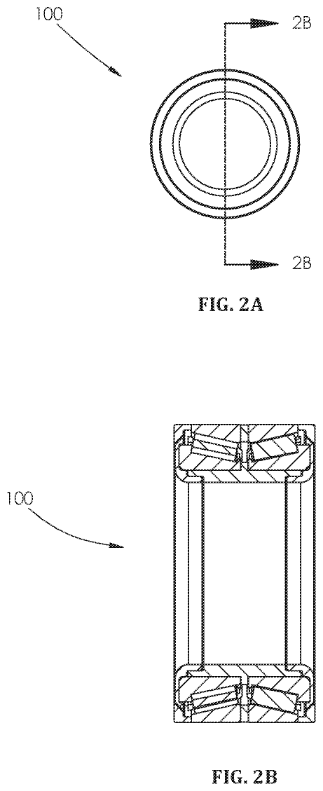

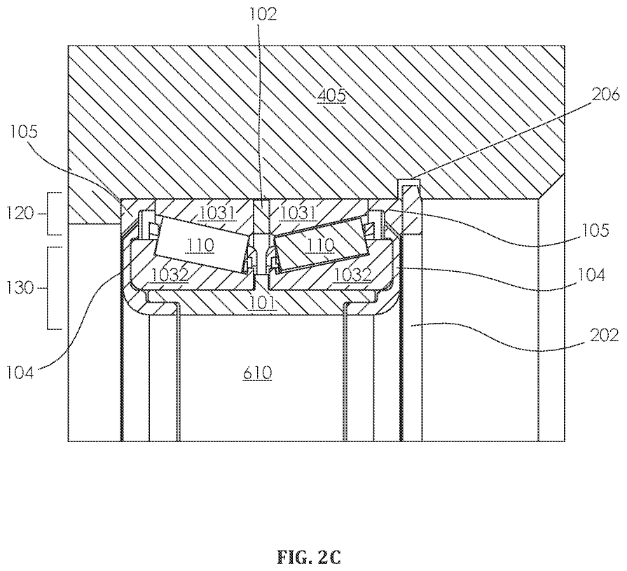

Conventionally, preloaded bearings have been used on an external basis, such as by sliding the bearing onto a shaft and fastened the bearing, and preloading the bearing, based on a position on the shaft, such as by tightening the bearing on the shaft with a nut. To the contrary, and as shown, e.g., in Applicant's FIG. 2C, the present disclosure presents a new structure and method for internally mounting the bearing 100, such that the bearing 100 fits, and is internally mounted (or coupled with a female mounting) inside a bearing cup, bearing pocket, or recess 406 within a wheel bearing assembly 405, which is contrary to conventional external mounting that occurs by sliding a bearing onto a male type shaft, as is often present on trailers, tractors, and other vehicles.

Applicant has discovered benefits for the new double row tapered wheel bearing disclosed for in for applications with UTVs, such as for (but not limited to) the Polaris RZR platform. As user herein UTVs include utility terrain vehicles and universal task vehicles, as well as four-wheel drive vehicle, two-wheel drive vehicle, sandrails, dune buggies, all-terrain vehicles (ATV), trucks, off-road vehicles, sport utility vehicles, recreational vehicles, defense vehicles, race vehicles, competition type vehicles, or other similar vehicles, whether or not the vehicle is street legal, and whether the vehicle is powered by gasoline combustion engines, pre-detonation or diesel engines, or other engines using propane, natural gas, or any other fuel, as well as vehicles powered by electric motors. As such, the new double row tapered wheel bearing disclosed herein is applicable to the Polaris RZR platforms, and is also be applicable to other UTVs as well.

For example, Applicant has noted that Polaris machines, like RZRs, are often having wheel bearing issues with their double ball bearing split face bearing. For example, Applicant has noted that the double ball bearing split face bearing, Polaris Part #3514822, is susceptible to being contaminated by sand, dirt, mud, and water. Other examples include parts 3514924 and 3515090. In determining a structure or system that would overcome the above issues, Applicant considered a true automotive type tapered bearing, and in searching for such a suitable off the shelf solution, discovered that such a bearing of the correct dimensions, shape, size, and diameter, was not available. Additionally, while in theory adapting bearing dimension to a desired dimension, shape, size, and diameter, so as to fit within the parameters of the stock RZR hub, the machining precision to produce such a part is technically difficult and expensive to the point it is rendered impractical and unsuitable for its intended use. The manufacture of bearings, such as to form a new bearing for an existing bearing pocket, is such a specialized process and requires such precision, that only a few companies in the world have the equipment and expertise to perform the work. Additionally, modifying the parameters of the stock RZR hub is also impractical, and is a decision at the discretion of Polaris. In light of the considerations noted above, Applicant developed a new system in which existing bearings may be used with additional components that may be produced or machined with less technical difficulty than machining the bearing itself, so as to produced improved results for UTVs, like the Polaris RZRs.

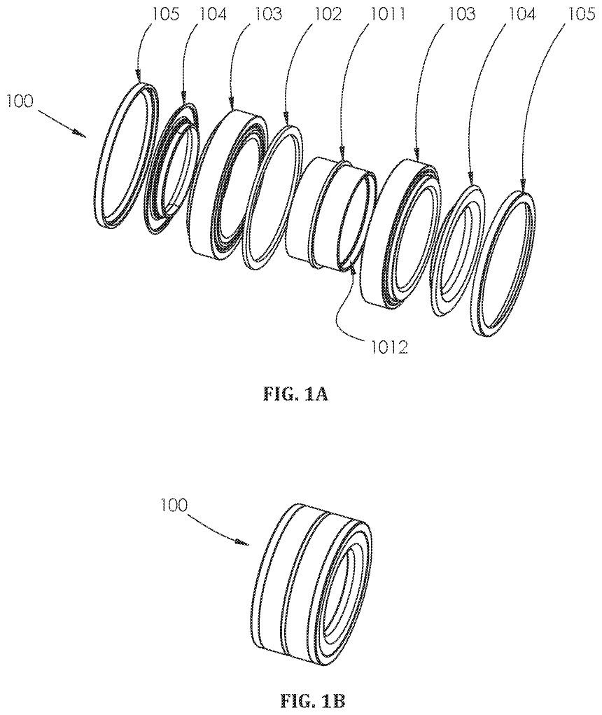

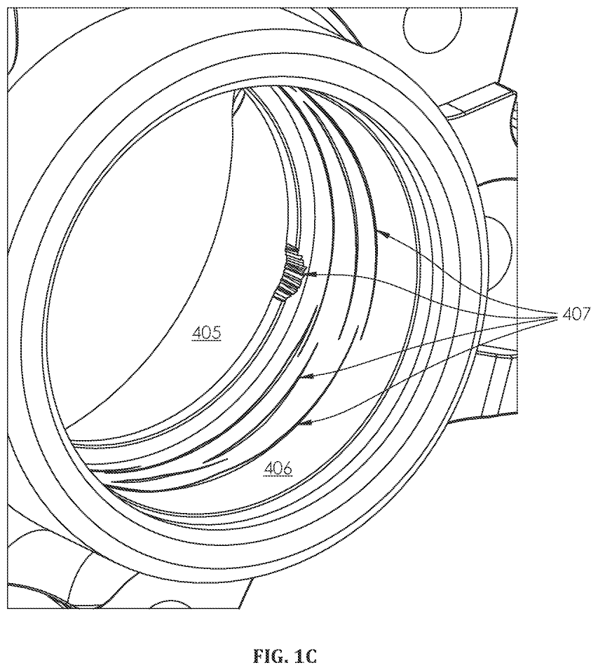

FIGS. 1A-2C depict various views of a sealed double row tapered roller bearing 100, according to an aspect in which the bearing 100 comprises a device or assembly formed as a double row bearing comprising two single row bearings. Among the figures, like elements are represented by like element numbers or items numbers. Element 101 is an inner sleeve. Element 102 is an outer spacer. Element 103 is a bearing or a single row bearing, such as an angular wheel bearing assembly or a tapered bearing. Element 104 is an inner diameter (ID) shield. Element 105 is an outer diameter (OD) shield. All of the elements 101-105 shown in the figures may be made of metal, such steel, aluminum, or other desirable material. As shown in the figures, the outer spacer 102 and the two single row bearings or angular/tapered bearings 103 can be mounted/attached to an inner sleeve 101. Two ID shields 104 are press fit onto the outsides of the opposing inner races, and two outer diameter shields 105 are press fit onto the outsides of the two opposing outer races.

FIG. 1A depicts an exploded perspective view of a sealed double row tapered roller bearing 100 with inner diameter shields 104 and outer diameter shields 105. Inner sleeve 101 allows for the ID of a standard bearing with a desired outer diameter to be adjusted to a correct size for a standard shaft. The inner sleeve 101 comprises an outer ridge 1011 in the center of the sleeve 101 to keep the two tapered bearings 103 apart enough so that the tapered roller cages do not touch when assembled. The inner sleeve or race 101 also comprises a step, notch, recess, or channel 1012 along the inside or inner diameter, opposite the center ridge 1011 at the outer diameter that allows for bearing load transfer and sealing of the rollers within the bearings 103 from contamination by being mateably coupled with ID shield 104, which is discussed in greater detail below. As shown, e.g., in. FIGS. 2A and 2C, inner sleeve 101 can hold 70%, or about 70%, of the inner race of the bearing 103 in place while maintaining its center mass. The OD of the bearings 103 stays the same maintaining the load rating of the bearings 103 in the new bearing system and structure, while the inner diameter of ID shield 104 steps down to allow for strength of inner sleeve 101 and bearings 103 to be maintained while being mateably coupled with ID shield 104. Taken together, ID shield 104 allows the main dynamic load of the bearing assembly to be supported by a robust structure comprising interrelated parts for improved size, seal, and loading.

Outer spacer 102 is designed to set the preload of the outer races 103, which ultimately will set preload on the bearings 103. As such, a method of assembling and using the above described device is also contemplated, to allow a desired amount of preloading to be set for the bearing. Too much preload will cause the bearing to over-heat and fail. Too little preload allows unwanted relative movement of bearings and undesired movement/vibration of the objects the bearing supports. Unlike conventional bearings where the preload is fixed and is not adjustable, the current assembly provides for customization of bearing preloading, an amount of which may be adjusted or controlled by the c clip or snap ring 202 with a tapered end being disposed within a notch, recess, or channel 206, of the bearing housing 204, as shown in FIG. 2C. The outer spacer 102 is designed to be thicker than the outer ridge 1011 of inner sleeve 101, allowing outer races of the bearings 103 to contact the outer spacer 102 while the inner races of the bearings 103 do not contact the inner ridge of inner sleeve 101,

In some instances, the bearings 103 may be SKF bearing part #32910, which is a tapered roller bearing that comprises an outer diameter matching application for Polaris and other UTVs. Using a premanufactured bearing as part of a new bearing assembly allows for customized size and performance, without undertaking the expensive and difficult precision manufacturing required for creating the bearing itself.

ID shield 104 may mateably couple with inner sleeve 101 in a way that allows the bearings 103, the inner sleeve 101 and the ID shield 104 to operate as a composite, functional, or complete unit. ID shield 104 slides into inner sleeve 101 so as to maintain the strength of the outer edge of the bearing 103, while also providing for a precise or water-tight fit that acts as a seal to protect contamination from entering through the ID of the bearing. Applicant has discovered a flaw with conventional or original equipment manufacturer (OEM) ball bearings, in that they do not seal on the ID of the bearing, allowing unwanted debris and contaminates to enter the bearing to decrease bearing performance and reduce bearing life as a result of damage or wear and tear being incurred on the bearing.

ID shield 104 also provides for the additional benefit of setting preload by allowing the inner races on the ID portion of bearings 103 to keep sliding inward (in response to ID shield 104), thus applying pressure on the inner race of the tapered roller bearing which makes the pressure increase on the outer spacer 102 adding the outer race preload. ID shield 104 also wraps the inner race of the bearing 103 in a way that allows the entire inner race of the bearing 103 to spin freely, not interfering with the outer race of the bearing 103, the outer race of the bearing 103 being pressed into the bearing housing and not rotating at all, as described with respect to FIG. 2C.

ID shield 104 may also comprise its top edge being tapered in a way to act as a diagonal shield to begin the sealing process. This may be a delicate process in creating the “sealed tapered roller bearing” to function. The diagonal taper also holds the outer edge of the tapered roller cage, the diagonal taper constraining or trapping tapered roller cage so as to prevent the tapered roller cage from sliding upwards and slipping out and off the inner bearing race 103. This allows the entire assembly to be held together, and function in a way similar to a traditional tapered roller bearing. In the present arrangement, however, the shields 104 and 105 allow the bearing to be “sealed” to advantageously prevent dirt, sand, mud, water, and other foreign debris from entering/contaminating and decreasing performance of the bearing.

OD shield 105, as noted above, allows the bearing to be “sealed” with the interaction of shield 104, by having a tapered angle opposite to the tapered angle of shield 104. The angle of OD shield 105 forces any potential contamination to travel upward and inward making it a more natural barrier of defense against contamination. OD shields 104 and 105 overlap when viewed from an axial direction of the shaft, preventing line of sight into the bearing rollers (or balls) reducing or preventing contamination from entering the bearing, reducing or preventing a straight horizontal gap which would be an easier route for contamination to enter. The interface at of OD shields 104 and 105 at their overlap may comprise an integrated seal, such as a swiper seal.

OD shield 105, in addition to allowing the bearing to be “sealed” with the interaction of shields 104 and 105, may push the outer race 103 inward towards a position to not let the bearing to be over loaded by setting to much preload. As seen in FIG. 2C, this may be accomplished by having the OD shield 105 rests against a shouldered edge on “one side” of the bearing pocket, which traps the bearing and stops it from moving. The “other side” OD shield 105, opposite the shouldered edge, may be held in place by c clip or snap ring 202, which is also shown in FIG. 2C. This arrangement traps the bearings 103 into the pocket so that the axle can now slide thru allowing the bearing 103 to be installed in its final position. The tapered snap ring 202 allows the bearing 103 to have a constant preload without a human/installer tightening a nut to add preload to the bearing, as would be done with a conventional arrangement. As noted above, in some instance OD shield 105 may advantageously include a sealed rubber lip, or swiper seal, integrated in the ID tapered edge to provide a stronger seal and further prevent contaminants from entering the bearings 103, allowing the bearing assembly to function as a sealed bearing.

FIG. 1B depicts a non-exploded perspective view of the sealed double row tapered roller bearing or bearing assembly 100 of FIG. 1A. The outer radial surface of the top is formed of multiple pieces, including upper seals or OD shields 105, upper or outer races of bearings 103, and the outer spacer 102. While the composite double row tapered bearing with press fit preloading elements 100 may function well in bearing pockets or cavities with tight tolerances, in situations where tolerances are not tight (such as when variation or inconsistencies of even 20 thousandths of an inch) are introduced among different vehicle hubs and bearing pockets, the additional space may prove problematic and cause unwanted movement of the bearing assembly 100 that results in damage to the hub, including the bearing pocket for the hub, and decreased performance or part failures.

FIG. 1C shows an image of carrier bearing wheel assembly or wheel bearing assembly 405 comprising the bearing cup or bearing pocket 406 that housed the bearing 100 when tolerances allowed for undesired movement of the bearing 100 within the bearing cup 406, that resulted in damage or scaring 407 to the bearing cup 406 and wheel bearing assembly 405.

FIG. 2A depicts a side profile view of the sealed double row tapered roller bearing 100 from FIGS. 1A and 1B that further includes section line 2B-2B, from which the view of FIG. 2B is taken.

FIG. 2B depicts a cross-sectional view of the sealed double row tapered roller bearing 100 taken along the section line 2B-2B shown in FIG. 2A.

FIG. 2C depicts an enlarged cross-sectional view of an upper portion of the sealed double row tapered roller bearing 100 from FIG. 2A, in which the fixed or stationary elements that do not rotate are the outer diameter elements 120 that include both outer diameter shields 105 (shown on the left and right of the FIG.), the outer diameter races 1031 (shown on the left and right of the FIG.), and the outer spacer 102. The rotating elements that do rotate with the CV joint shaft 610 are the inner diameter elements 130 that include both inner diameter shields 104 (shown and the left and right side of the FIG.), the inner diameter races 1032 (shown on the left and right of the FIG.), the inner sleeve 101, and the rollers 110.

While the upper diameter elements 120 are tightly held together, the inner diameter elements 130 include gaps/spaces between ID shields 104 and the inner diameter race 1032 of bearing 103, as well as between the inner race 1032 of bearing 103 and the inner sleeve 101. As opposing ID shields 104 are pressed towards each other and towards the central ridge 1011 of inner sleeve 101, the ID races 1032 of bearings 103 move towards each other and push upwards against the rollers 110 of the bearings 103 such that the OD races 1031 of bearings 103 increase in preloading. A desired level of preloading can be applied by pushing the press-fit ID shields 104 together, before placing them within the wheel bearing assembly 405, allowing for customization of preloading of the Sealed Double Row Tapered Bearing 100, a feature previously unavailable.

Applicant's new system provides a solution that does not require the high precision machining required for producing a new bearing, but allows an existing bearing to be introduced into a new composite component that can service the preset dimensions that are on millions of Polaris UTVs. Applicant's new system provides a solution that provides good strength, ameliorates sealing problems, and addressing preloading issues and strengthens load bearing capacity over existing OEM parts.

Applicant's new system provides the features of: (i) two ID shields 104 press fit onto the outsides of the opposing inner races 1032; (ii) two OD shields 105 press fit onto or adjacent the outsides of the two opposing outer diameter races 1031; (iii) the ID shields 104 and OD shields 105 sealing the bearing 100 to prevent foreign debris from contaminating the bearing 100, and (iv) a method of setting a desired amount of preload as opposing ID shields 104 are pressed towards each other and towards the central ridge 1011 of the inner sleeve 101. Furthermore, the additional improvements of: (i) a tapered snap ring 22 being fit into a notch, recess, channel, or slot 206 in the bearing housing or wheel bearing assembly 405; and (ii) the pliable/deformable/rubber ridges and angled shoulder between the ID shield 104 and the OD shield 105 that seal the bearing device are also present.

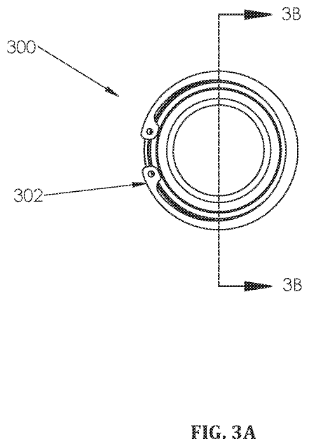

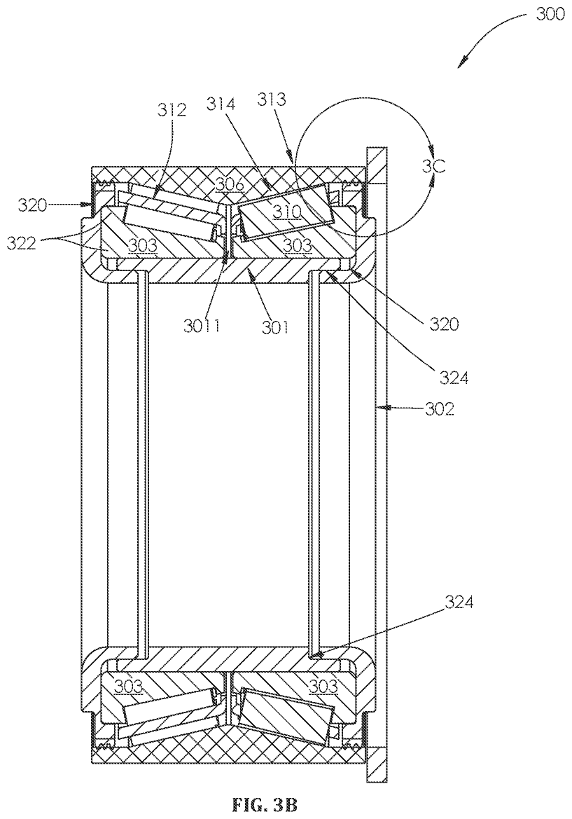

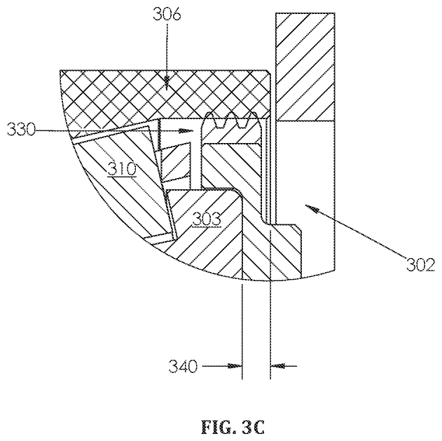

FIGS. 3A-3C depict various views of a bearing, bearing assembly, or double row tapered bearing with press fit preloading element 300 according to another aspect. FIG. 3A also shows a non-tapered c clip or snap ring 302 adjacent the bearing 300.

FIG. 3B depicts a cross sectional profile view of bearing 300 taken along section line 3B-3B shown in FIG. 3B. Like bearing 100, bearing 300 illustrates another aspect of double row tapered bearing with press fit preloading elements comprising an inner sleeve 301 comprising an outer ridge 3011 on the inner sleeve 301. The bearing 300 may be held in place within a bearing cup or bearing pocket 406 within the carrier bearing wheel assembly or wheel bearing assembly 405 with c clip or snap ring 302.

Like the bearing 100, the bearing 300 may comprise, or be formed with, components from separate individual single row tapered bearings. FIG. 3B shows the bearing 300 may comprise inner diameter races 303 of multiple single row bearings, such as an angular wheel bearing assembly or a tapered bearing 303. While two single row bearings 303 are shown in FIG. 3B, any number of suitable single row bearings may be used, based on a desired implementation, such as four single row bearings or any number of single row bearings 303. The rings of tapered rollers 310 may be arranged face-to-face (where load lines converge), in a back-to-back arrangement (where load lines converge), in matched pairings where adjacent rings of rollers 310 or ID races 303 are arranged in tandem, or any combination of the above. In any event, by using tapered roller bearings, thrust loads applied to the bearings 300, such as through wheels or tires 505 of a UTV may be better supported than with other ball bearings or roller bearings.

Rollers 310 may be disposed within, or spaced apart by, a cage or spacer 312 while positioned circumferentially around the inner diameter races 303. An outer diameter (OD) race or OD double race 306 may be disposed opposite the ID races 303, sandwiching the rollers 310 between the ID races 303 and the OD race 306. Unlike with bearing 100 that had a segmented or multi-component OD race, the OD race 306 of the bearing 300 may comprise a single or integrally formed unitary OD race 306. The OD race 306 may comprise angled, sloped, or tapered inner diameter surfaces 314 that align, and are mateably coupled, with rollers 310. The inner tapered radial surfaces 314 may comprise a first angled surface and a second angle surface that meet at a circular ridge.

In other words, FIG. 3B illustrates a UTV double row tapered wheel bearing assembly 300 comprising an inner sleeve 301 comprising an outer radial surface with a radially aligned circular ridge 3011 that separates a first inner race 303 and a second inner race 303 (shown, e.g., on left and right sides of FIG. 3B). The first inner diameter race 303 may be disposed around a first portion of the outer radial surface of the inner sleeve 303. A second inner diameter race 303 may be disposed around a second portion of the outer radial surface of the inner sleeve. An outer diameter race 36 may be radially offset from the first inner diameter race 303 and the second inner diameter race 303, the outer diameter race 306 comprising an outer flat radial surface 313 and an inner tapered radial surface 314 opposite the outer flat radial surface 313. The outer diameter race 306 may be formed as a single integral member with an axial length La greater than an axial length measured between the axial surfaces of the ID races 303. Similarly, the outer diameter race 306 may comprise an axial length La greater than an axial length of the inner sleeve 301, so that the outer axial surfaces of the OD race 306 overhang or are offset with respect to the outer axial surfaces of the ID races 303 and the outer axial surfaces of the inner sleeve 101, where the axial direction is aligned with the direction of the shaft, wheel axle, or CV joint shaft 610. As shown in FIG. 3B, the radial length Lr is orthogonal to the axial length La.

A first ring of rollers 310 may be disposed between the outer diameter race 306 and the first inner diameter race 303. A second ring of rollers 310 may be disposed between the outer diameter race 306 and the second inner diameter race 303, and further be offset from the first ring of rollers 310. The rollers 310 of the first ring of rollers and of the second ring of rollers may all be cylindrically shaped. Alternatively, the rollers 310 of the first ring of rollers and of the second ring of rollers may be frustoconically shaped. In either event, a size of the first ring of rollers (or rollers 310 within the first ring of rollers) may be equal to a size of a second ring of rollers (or rollers 310 within the second ring of rollers).

A first shield 320 may be coupled to a first axial face of the bearing 300, and a second shield 320 coupled to the second axial face of the bearing 300 (such as on opposing left and right sides of the FIG. 3B. The first shield 320 and the second shield 320 may be configured to seal the interior of the bearing 300 (including the rollers 310 and cage 312 of the first ring of rollers and the second ring of rollers) from external contaminates, such as dust, water, mud and other foreign debris from entering/contaminating and decreasing performance of the bearing. The first shield 320 and the second shield 320 may each comprise a bearing seal, sealed rubber lip, or swiper seal 330, that may be integrated in the OD edge to seals 320 to provide a stronger seal and further prevent contaminants from entering the bearings 300, allowing the bearing assembly to function as a sealed bearing. As shown in FIGS. 3B and 3C, the seal 330 may be formed of comprising a plurality of lips or ridges, such as three lip seals that contact the inner radial surface of the outer race 306. The outer race 306 may comprise an overhang 340 of the ID races 303 to facilitated the seals 330 mateably coupling with the inner surface of the OD race 306. In other instances, other suitable sealing configurations may also be used. The seal 330 may be formed of rubber or any other suitably deformable, durable, and temperature resistant material. The first shield 320 (as well as the second shield 320) may be press fit on ID and OD shoulders 322 of the first ID race 303 and further seal with a stepped surface 324 of the inner sleeve 301. The bearing seal 300 may provide a stronger seal and further prevent contaminants from entering the bearings 300, allowing the bearing assembly to function as a sealed bearing to advantageously prevent dirt, sand, mud, water, and other foreign debris from entering/contaminating and decreasing performance of the bearing 300. Heretofore, OEM assemblies on the Polaris RZR, Can Am, Kawasake, Hona, Textron, and others have included internal split face bearings, which have allowed contaminants to enter and damage the bearing, such as when entering water or mud with the UTV.

FIG. 3C depicts a close-up cross-sectional profile view of the portion of the bearing 300 shown by section line 3C from FIG. 3B. FIG. 3C. also shows that the bearing seals 330 may be elastically deformable and deform by an amount in which the seals 330 radially extend beyond the ID surface of the OD race 306, such as about 8 thousandths of an inch, or about 0.02032 mm.

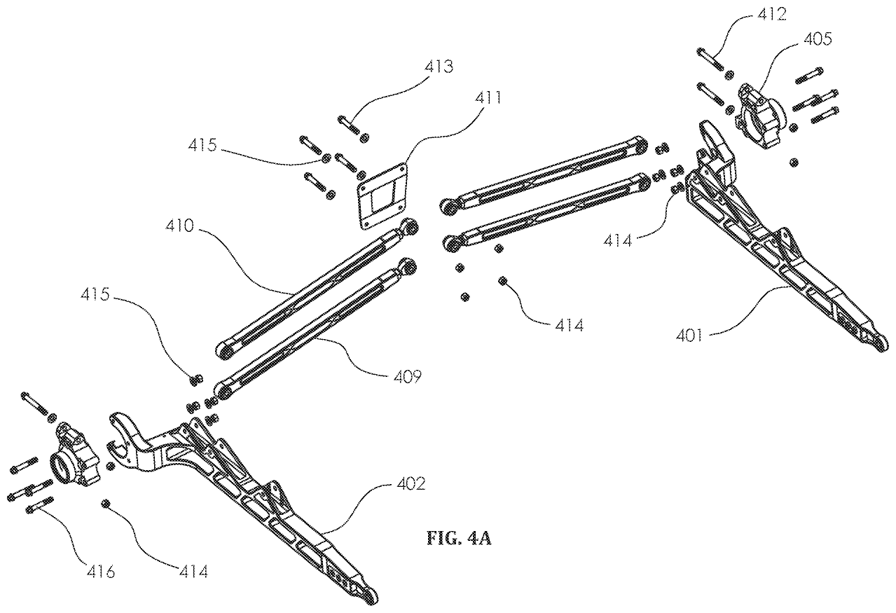

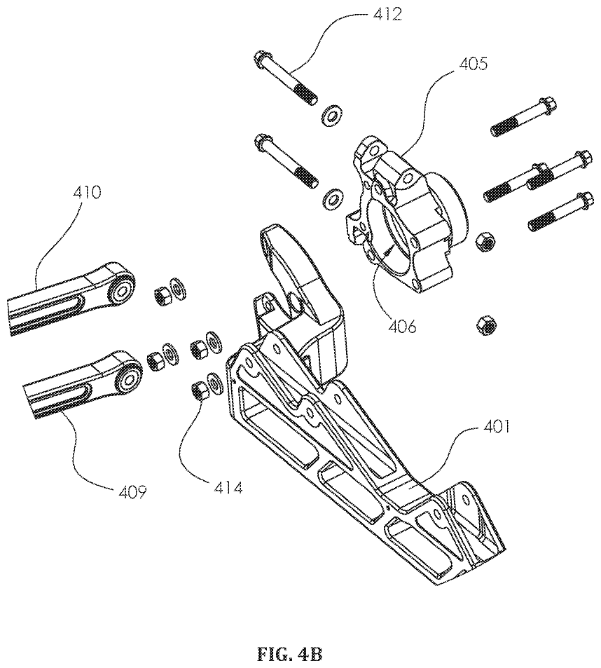

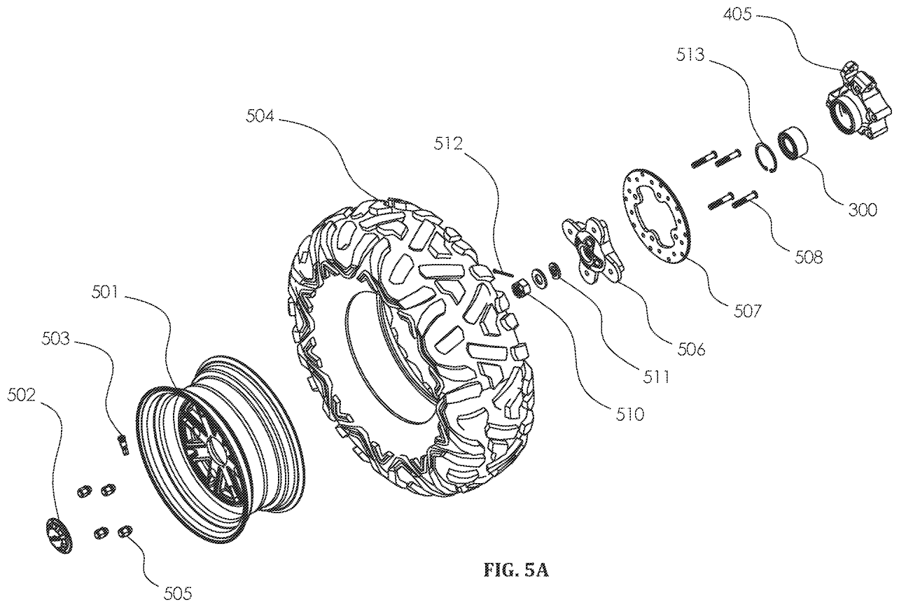

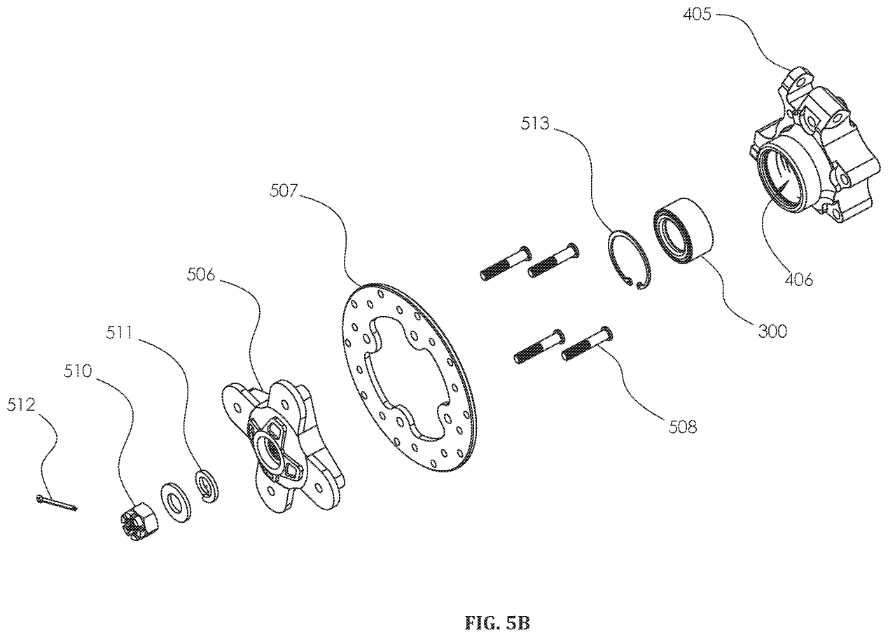

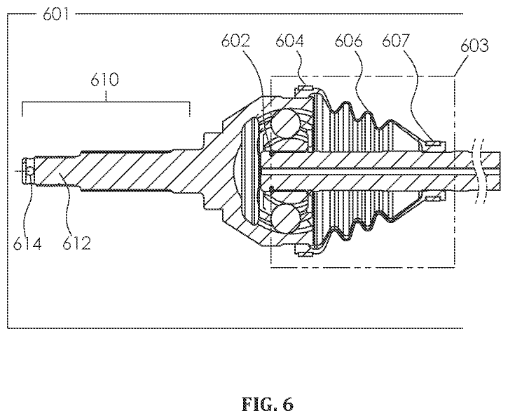

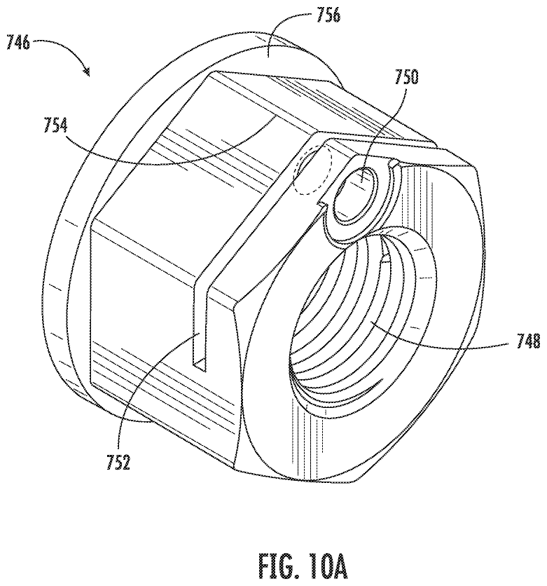

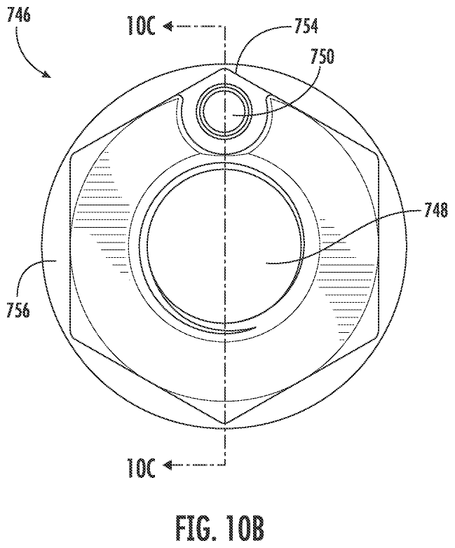

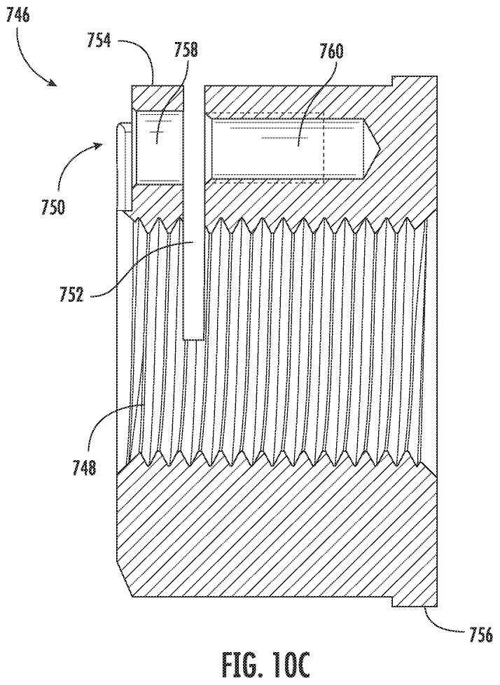

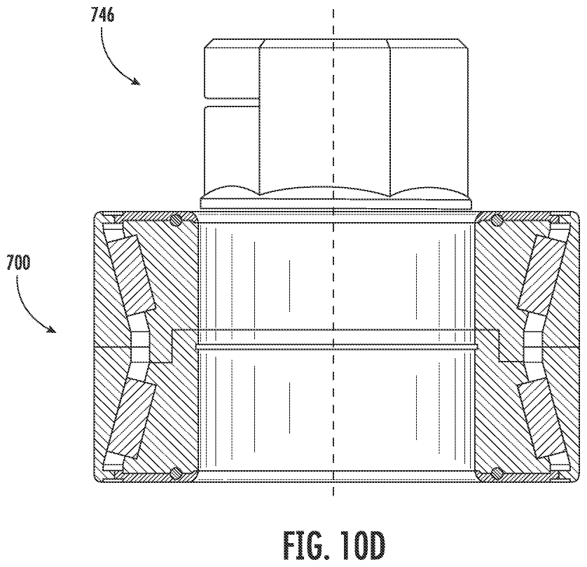

The bearings 300 may be used for UTV wheel shafts or CV joint axles 610 by being coupled to the CV joint shaft 610 (shown in FIG. 6) and disposed between the carrier bearing wheel assembly or wheel bearing assembly 405 and the wheel hub 506, as shown, e.g., in FIGS. 4A-5B. The bearing 300 may also be preloaded by tightening a nut, castle nut, pinch bolt clamp, or pinch clamp nut 510 on the CV joint shaft 610 to press the bearing 600 against the snap ring 302 by applying 10-180 ft-lbs of torque, or 5-140 ft-lbs of torque, or about 120 ft-lbs of torque to the nut. The nut then applies a force to the bearing 300, and transferring force through a first shield 320 to a first ID race 303 the inner sleeve 301 (including the ridge 3011), the second ID race 303 and the second shield 320. After the nut is tightened to a preferred amount of force, the nut 510 may be secured, and prevented from undesirably backing off or loosening, by being further secured to the CV joint shaft 610 with a cotter pin 512, or through the use of a pinch nut 746 as disclosed in more detail below with reference to FIGS. 10A-10D. The amount of torque that is applied is influenced by the type of bearing that is used. For example, ball bearings require a higher amount of torque than tapered bearings. In some tapered bearings, between 0 and 24 ft-lbs of torque may be applied. The proper level of torque is dependent on the size of the bearing 100, 300, 700 and the bearing pocket 406. For example, in embodiments where the bearing is smaller, a smaller torque may be required, and in embodiments where the bearing is larger, a larger torque may be required to set a same amount of preload for the bearing based on the different surface area or contact length at an interface between the rollers 110, 310, and 725 with respect to their corresponding races 1031 and 1032, 303 and 306, and 702 and 704, respectively.

When force is applied to the ID races 303, some force is proportionally transferred to rollers 310, moving them more tightly against the stationary OD race 314, increasing the preload on the rollers 310 and the bearing 300. As the preload is increased, some movement of the rollers 310 may also occur, moving the roller closer towards the ridge 3011 or the center of the bearing 300. Movement during preloading may be facilitated by a gap, space, or offset G, that occurs between the shield 320 and the radial surfaces of the inner sleeve 301. Even with a gap G between the radial surfaces of the inner sleeve 301 and the shields 320, the shield 320 may tightly contact and form a waterproof seal with the stair-step 324 or axial surface of the inner sleeve 301.

FIGS. 4A and 4B depict various views of UTV rear suspension elements compatible with improved UTV performance resulting from use of a sealed double row tapered roller wheel bearings 100, 300. FIG. 4A shows the rear suspension for a Polaris Razor, the left of the figure being the rear of the vehicle and the right of the figure being oriented towards the front of the vehicle. Element 401 is a left side rear control arm, element 402 is a right side rear control arm. Element 405 is a carrier bearing wheel assembly or wheel bearing assembly. Element 406 is bearing cup or bearing pocket within wheel bearing assembly 405, into which bearings 100, 300 may be disposed. Elements 409 and 410 are ASM-radius rod or control arm, which may also be referred to as a radius arm, torque arm, or torsion bar. Element 411 is a rear plate or bolt brace, elements 412, 413, 416 are mechanical fasteners or bolts, and elements 414 and 415 are mechanical washers or nuts. FIG. 4B in an enlarged close-up view of the left side rear control arm 401 and the wheel bearing assembly 405.

FIGS. 5A and 5B depict views of a UTV rear wheel elements compatible with improved UTV performance resulting from use of a sealed double row tapered roller wheel bearings 100, 300. FIG. 5A shows the tire or wheel assembly for a right rear tire of a Polaris Razor, the left of the figure being the right rear of the vehicle. Element 501 is a wheel rim, element 502 is a rim cap, element 503 is a rim valve, element 504 is a tire, and element 505 is a wheel nut or lug nut. Element 506 is a wheel hub (with splines on inner annular surface to mateably couple with the splines of the CV joint shaft 610), element 507 is a disk brake or rotor, while elements 508 are wheel studs or lug bolts. Element 510 is a nut, castle nut, pinch bolt clamp, pinch clamp nut, or a shouldered pinch clamp nut. Elements 511 are washers, element 512 is a cotter pin, and element 513 is a retaining ring. The wheel hub 506 may include a seal (not shown) that is configured to contact the bearing 100, 300, 700 when the rear wheel elements are assembled together. This may help reduce contamination of the inside of the bearing 100, 300, 700 with debris and fluid. FIG. 5B in an enlarged close-up view of the right side of FIG. 5A, and shows an enlarged view of the wheel bearing assembly 405, bearing 100, 300, and wheel hub 506. The wheel bearing assembly 405 is configured to be affixed to the suspension of the vehicle, as shown in FIGS. 4A and 4B. Thus, the wheel bearing assembly 405 does not rotate when the vehicle is in motion. However, the remaining components shown in FIGS. 5A and 5B rotate with the wheel or tire 504 when the vehicle is in motion.

FIG. 6 depicts a CV joint and boot assembly for coupling with the elements of FIGS. 4A-5B for improved UTV performance resulting from use of a sealed double row tapered roller wheel bearing 100, 300. While the bearing 100, 300 is not shown in FIG. 6, when assembled, the shaft 610 passes through the center or opening of the bearing 100, 300 and the bearings is disposed adjacent (and to the right of) the splines on shaft 610 as shown in FIG. 6. Broadly speaking, FIG. 6, and more particularly element 601, is a drive train rear half shaft assembly. Element 602 is a circlip, C-clip, rotor clip, or snap ring, element 603 is a boot kit, element 604 is a clamp or boot clamp, and element 610 is a wheel axle or CV joint shaft. Element 612 is the threaded surface of the shaft 610 for receiving the nut 510, and element 614 is an opening through the shaft 610 for receiving the cotter pin 512. Thus, the left side of the CV joint and boot assembly shown is configured to couple with the bearing 100, 300, 700 and the other components of the wheel, while the right side of the CV joint and boot assembly shown couples with the remaining portions of the vehicle.

When assembling a tire 504 to a UTV with the bearing 100, 300 as disclosed herein, a toe-in and toe-out camber of the tire will be desirably reduced from OEM configurations, with the camber (for a vehicle being jacked-up off the ground and no weight applied to the tire 504) being in a range of about 0-¼ in., or about 0- 3/16 in for tires 504 with diameters in a range of 27 in −37 in. As a result, the wheel bearing 100, 300 being preloaded radially with respect to the shaft 610 and sealed from contaminants provides improved strength and performance.

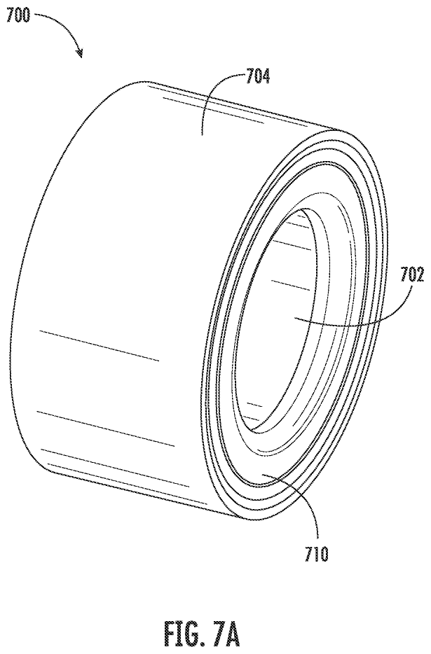

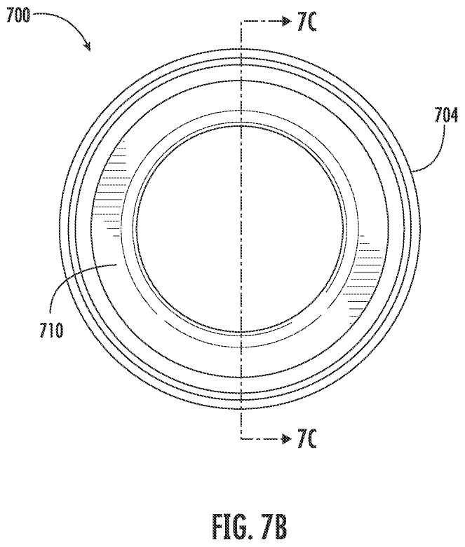

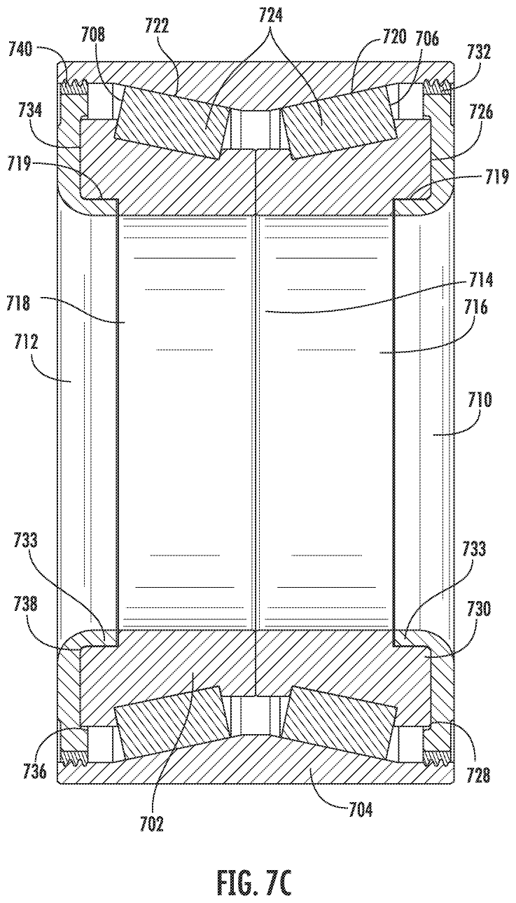

FIGS. 7A-7C illustrate another embodiment of a double row tapered roller bearing 700. Any of the features disclosed above with reference to the bearings 100, 300 may be combined with the features disclosed below with reference to bearing 700. Similarly, any features disclosed below with reference to bearing 700 may be implemented with the bearings 100, 300. The double row tapered roller bearing 700 is similar to the bearings 100, 300 disclosed above. For example, the bearing 700 may comprise a first race 702, a second race 704, a first roller bearing 706, a second roller bearing 708, a first shield 710, and a second shield 712. The first race 702 may have a center portion 714 extending between a first end 716 and a second end 718 of the first race 702. The first end 716 and the second end 718 may each have a stepped surface 719 with a first inner diameter, and the center portion 714 may have a second inner diameter. The first inner diameter may be greater than the second inner diameter.

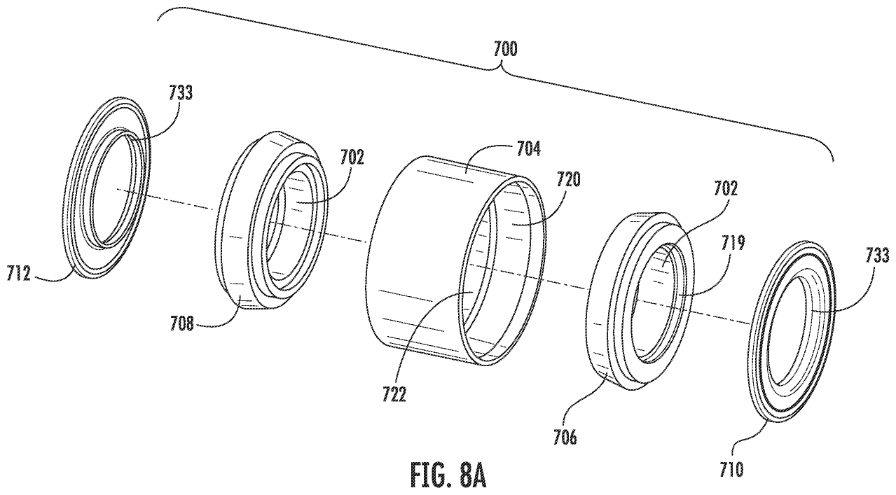

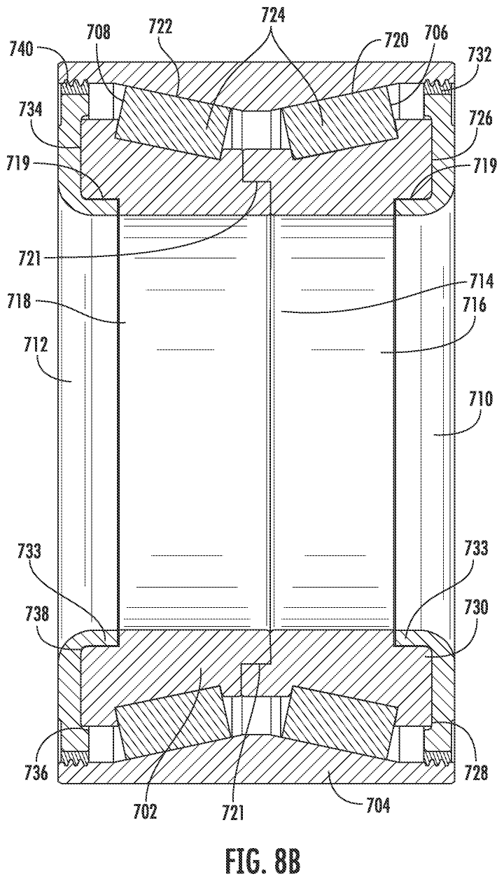

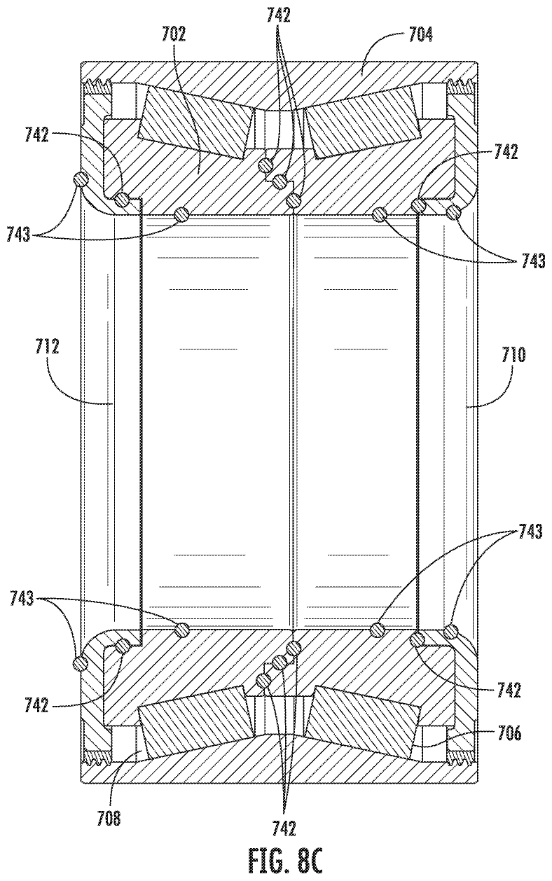

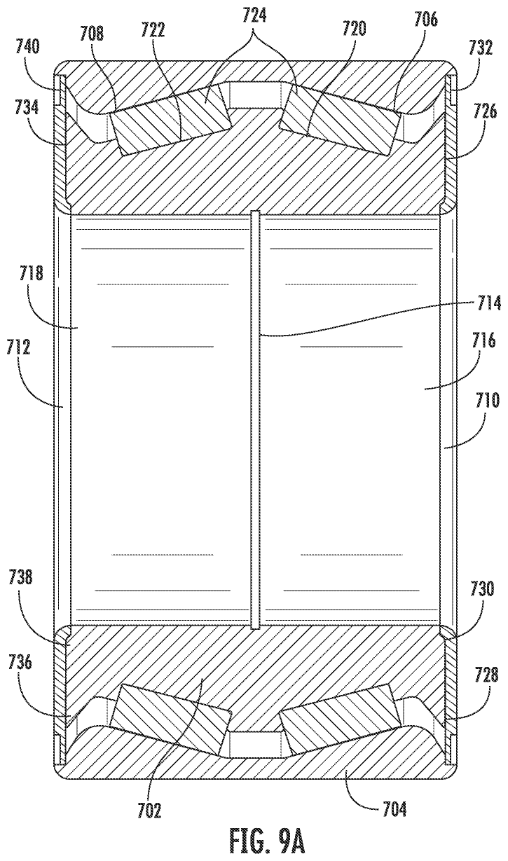

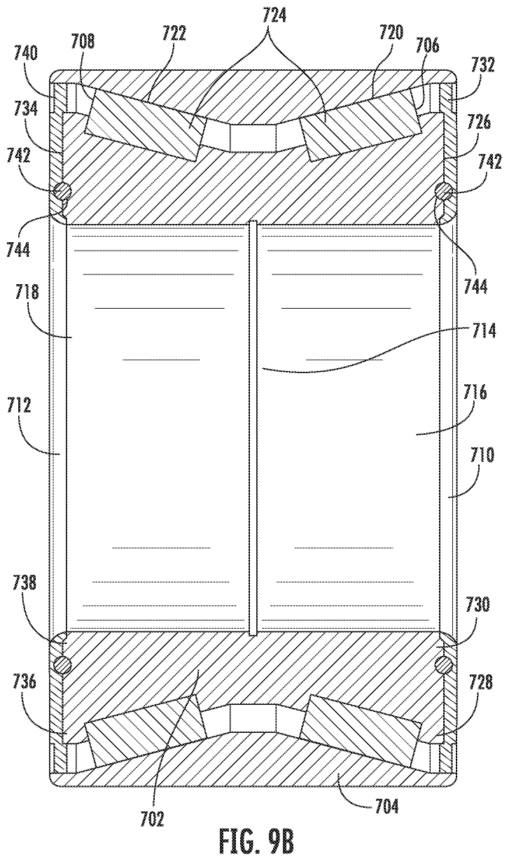

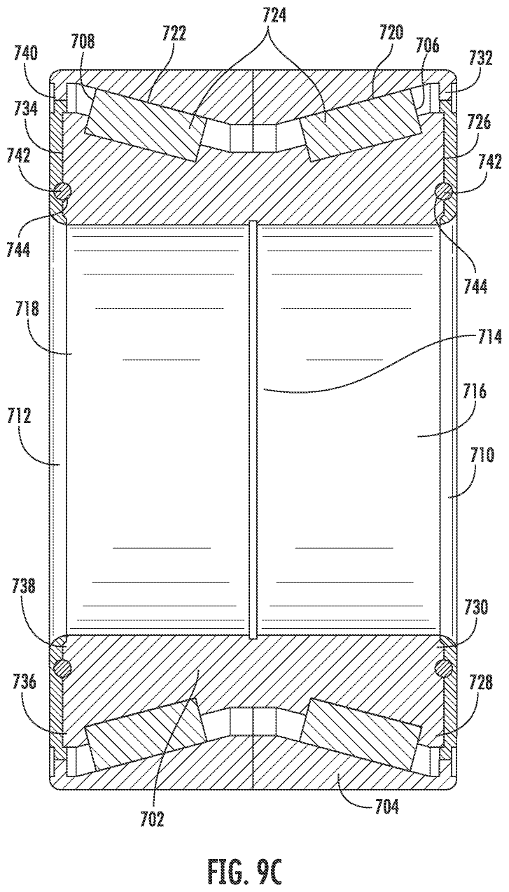

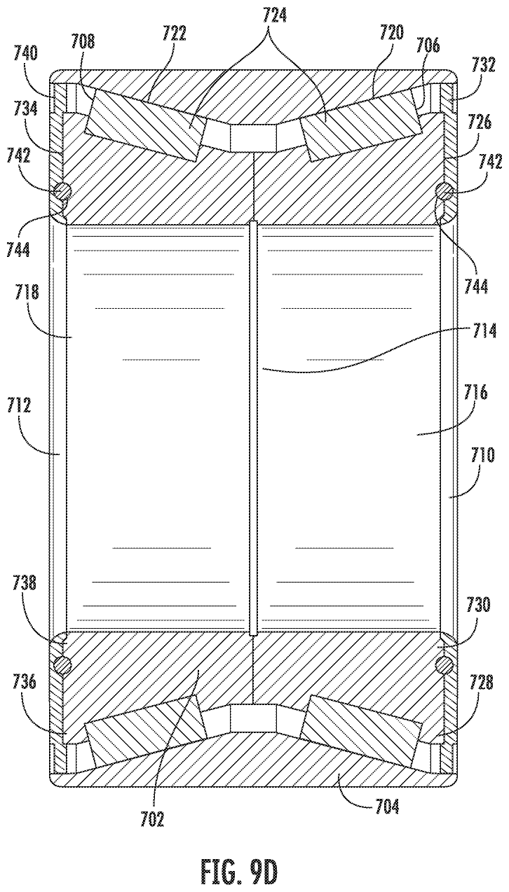

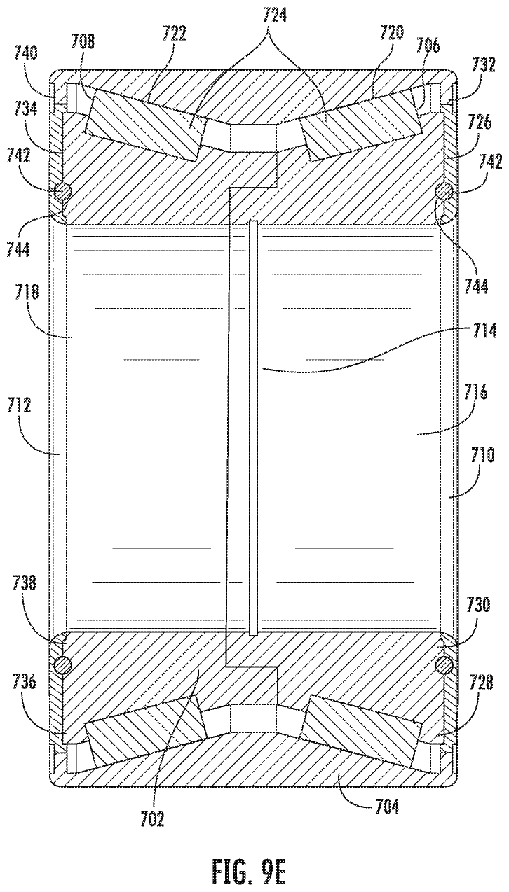

The first race 702 and the second race 704 may be an inner race 702 and an outer race 704. Thus, the second race 704 may be disposed around the first race 702. In some embodiments, the first race 702 and/or the second race 704 are formed of one unitary piece. In other embodiments, the first race 702 and/or the second race 704 are formed of multiple, distinct pieces. For example, as shown in FIGS. 7C, 8B, and 9D-9E, the first race 702 may be formed of two pieces. As another example, as shown in FIGS. 9A-9B, the second race 704 may be formed of two pieces. Thus, the first race 702 may comprise two pieces that together form the center portion 714 that extends between the first end 716 and the second end 718. In some embodiments, the two pieces are configured to interlock with each other, as shown in FIGS. 8A, 8B and 9E. Each of the pieces may have a stepped surface 721 that functions similar to the stepped surface 719. The stepped surface 721 of a first piece of the two pieces may be configured to mate with the stepped surface 721 of a second piece of the two pieces, as shown in FIG. 8B, thus allowing the two pieces to interlock. The first race 702, the second race 704, or both, may have a first surface 720 and a second surface 722, as shown in FIGS. 7C, 8B, and 9A-9E. The first surface 720 and the second surface 722 may be inner surfaces, and may be angled. Additionally, the first surface 720 and the second surface 722 may form a peak, plateau, or slant or angle towards each other.

The first roller bearing 706 may be positioned between the first race 702 and the second race 704, and may have a plurality of rollers 724 that are configured to engage with the first surface 720. Similarly, the second roller bearing 708 may be positioned between the first race 702 and the second race 704, and may have a plurality of rollers 724 that are configured to engage with the second surface 722. Thus, the first roller bearing 706 and the second roller bearing 708 engage with one of the first race 702 and the second race 704 to create the preload discussed above.

The first shield 710 is configured to engage with an edge 726 of the first roller bearing 706. The first shield 710 may be configured to engage with the entire face of the edge 726, or alternatively with just a portion of the edge 726. For example, the first shield 710 may be configured to engage with an outer portion 728 of the edge 726, with an inner portion 730 of the edge 726, or both the outer portion 728 and the inner portion 730 of the edge 726. The first shield 710 is configured to push the first roller bearing 706 against the first surface 720. The first shield 710 may comprise a seal 732 that is configured to reduce passage of fluid into or out of the first roller bearing 706. The seal 732 may be formed of a rubber material and may contact the second race 704. The seal 732 may also be formed of a steel material, or a combination of rubber and/or steel with other materials. In some embodiments, the seal 732 may be part of the second race 704 and may contact the first shield 710, as shown in FIG. 9C. The first shield 710 may also comprise one or more guiding lips, such as guiding lip 733 that is configured to engage with the stepped surface 719 of the first end 716 of the first race 702.

Similar to the first shield 710, the second shield 712 is configured to engage with an edge 734 of the second roller bearing 708. The second shield 712 may be configured to engage with the entire face of the edge 734, or alternatively with just a portion of the edge 734. For example, the second shield 712 may be configured to engage with an outer portion 736 of the edge 734, with an inner portion 738 of the edge 734, or both the outer portion 736 and the inner portion 738 of the edge 734. The second shield 712 is configured to push the second roller bearing 708 against the second surface 722. The second shield 712 may comprise a seal 740 that is configured to reduce passage of fluid into or out of the second roller bearing 708. The seal 740 may be formed of a rubber material and may contact the second race 704. In some embodiments, the seal 740 may be part of the second race 704 and may contact the second shield 712, as shown in FIG. 9C. In other instances, the seal 740 may be a separate part from any race, such as race 704, and may contact the second shield 712. The second shield 712 may also comprise a guiding lip 733 that is configured to engage with a stepped surface, such as the stepped surface 719 of the second end 718 of the first race 702.

As mentioned above, the first race 702 and/or the second race 704 may have a first surface 720 and a second surface 722 that may be angled to form a peak. FIG. 9A illustrates an embodiment in which the first surface 720 and the second surface 722 are on the inner race 702, while FIGS. 7C, 8B, and 9B-9E illustrate embodiments in which the first surface 720 and the second surface 722 are on the outer race 704. As shown in FIGS. 8C and 9B-9E, the bearing 700 may also have one or more seals 742 positioned between the first shield 710 and the first race 702, between the second shield 710 and the first race 702, and/or between the two pieces of the first race 702. Specifically, FIG. 8C illustrates various possible locations for the seals 742. A seal 742 may be positioned in all of these positions, in a plurality of these positions, just one of these position, or none of these positions. Similarly, the bearing 700 may have a seal 743 positioned on an outer surface of the bearing 700, such as on the first shield 710, on the second shield 712, or on the inner surface of the inner race 702, and be configured to seal with another component of the assembly, such as the CV joint shaft 610, the wheel hub 506, the wheel bearing assembly 405, or at other suitable locations. Additionally, the illustrated positions are intended as examples, and the seal 742 may be positioned in other positions with the bearing 700 with similar effect. The seal 742 may be configured to reduce the passage of fluid into the bearing 700. One or more of the first shield 710, the second shield 712, and the first race 702 may have a sealing surface 744 that is configured to interact with the seal 742 to reduce the passage of fluid into the bearing 700. The sealing surface 744 may be a groove sized to receive the seal 742. Any of the seals disclosed herein, including seals 732, 740, 742, 743, may be any type of seal known in the art, being formed of one or more materials. In some embodiments, the seal 732, 740, 742, 743 comprise polymers such as polytetrafluoroethylene (PTFE) or any polymer, plastics, rubber, metal, steel as well as other natural, refined, or synthetic materials. Other materials may also be used or implemented. The seals 732, 740, 742, 743 may have a U-shaped, L-shaped, C-shaped, Z-shaped, or any other desired shape as a cross section. Additionally, the seals 732, 740, 742, 743 may have or comprise one or more lips, ridges, ribs, or protrusions. The seals 732, 740, 742, 743 may be integrally formed with the adjacent components of the bearing 700 to form a unitary piece, part, component, or element made of one or more than one material. For example, the seals 732, 740, 742, 743 may comprise a seal material bonded, adhered, or attached (such as rubber being rubber-bonded) to the bearing 700, where the seals 732, 740, 742, 743 are formed directly onto the bearing 700. The seals 732, 740, 742, 743 may also be formed separate from the bearing 700 and later installed during assembly as a separate, discrete element, part, or piece that is not unitarily or integrally formed.

FIGS. 10A-10D illustrate a pinch nut 746 that may be implemented with any of the bearings disclosed herein, including bearing 100, 300, and 700, to properly create and maintain the desired preload, similar to the nut 510 shown in FIG. 5A. The pinch nut 746 may have a through hole 748 extending through a center of the pinch nut 746, a pinch hole 750 positioned adjacent to the through hole 748, and a slit 752 cut into a side 754 of the pinch nut 746. The pinch nut 746 may also have a shoulder 756 configured to increase the surface area over which the preload is applied to the bearing 100, 300, 700, thus increasing the support of the pinch nut 746. The pinch hole 750 may be perpendicular to, parallel with, or diagonal to the through hole 748. The slit 752 is positioned to intersect with the pinch hole 750, dividing the pinch hole 750 into a first portion 758 and a second portion 760. Thus, the slit 752 may also be perpendicular to, parallel with, or diagonal to the through hole 748. The first portion 758 of the pinch hole 750 may be unthreaded, while the second portion 760 of the pinch hole 750 may be threaded. This allows a pinch bolt (not shown) to pass through the first portion 758 of the pinch hole 750 and then tighten into the second portion 760 of the pinch hole 750. This, in turn, causes the pinch nut 746 to clamp onto or pinch the shaft which passes through the bearing 100, 300, 700 and the pinch nut 746. This clamping or pinching motion is enabled by the slit 752. In this way, the pinch nut 746 can be tightened to a desired torque or preload, and then clamped there so that loosening (or undesired backing off) of the pinch nut 746 over time is reduced. This helps maintain the desired torque or preload at the correct amount, thus improving the performance of the bearing 100, 300, 700 over time. Additionally, the pinch nut 746 allows different preloads and torques to be achieved and maintained depending on the application. This makes the bearing 100, 300, 700 more adaptable. Lastly, because the pinch nut 746 can be clamped, tightened, or pinched onto the shaft at any rotational position, rather than requiring parts to align as with the OEM nut, the exact torque or preload can be achieved, rather than requiring the user to adjust to a slightly higher or lower torque in order to align the nut as needed to hold the nut in place. If desired, the pinch nut 746 can be removed by first loosening the pinch bolt from the pinch hole 750.

Accordingly, manufacture of these components separately or simultaneously may involve extrusion, pultrusion, vacuum forming, injection molding, blow molding, resin transfer molding, casting, forging, cold rolling, machining, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g., a bolt, a nut, a screw, a nail, a rivet, a pin, and/or the like), wiring, any combination thereof, and/or the like for example, depending on, among other considerations, the particular material forming the components.

It will be understood that the assembly of wheel bearings are not limited to the specific order of steps as disclosed in this document. Any steps or sequence of steps of the assembly of the wheel bearing assemblies indicated herein are given as examples of possible steps or sequence of steps and not as limitations, since various assembly processes and sequences of steps may be used to assemble wheel bearing assemblies.

What is claimed is:

1. A wheel bearing assembly, comprising:
an inner race having a center portion extending between a first end and a second end;
an outer race disposed around the inner race, the outer race having a first angled inner surface and a second angled inner surface, wherein the first angled inner surface and the second angled inner surface form a peak;
a first roller bearing positioned between the inner race and the outer race, the first roller bearing having a plurality of rollers configured to engage with the first angled inner surface of the outer race;
a second roller bearing positioned between the inner race and the outer race and adjacent the first roller bearing, the second roller bearing having a plurality of rollers configured to engage with the second angled inner surface of the outer race;
a first shield configured to engage with an outer edge of the first roller bearing and push the first roller bearing against the first angled inner surface of the outer race, the first shield comprising a rubber seal configured to reduce passage of fluid into or out of the first roller bearing; and
a second shield configured to engage with an outer edge of the second roller bearing and push the second roller bearing against the second angled inner surface of the outer race, the second shield comprising a rubber seal configured to reduce passage of fluid into or out of the second roller bearing.

2. The wheel bearing assembly of claim 1, wherein the seal of the first shield and the seal of the second shield each contact the outer race.

3. The wheel bearing assembly of claim 1, wherein the first end and the second end each have a stepped surface with a first inner diameter and the center portion has a second inner diameter, wherein the first inner diameter is greater than the second inner diameter.

4. The wheel bearing assembly of claim 3, the first shield further comprising a guiding lip configured to engage with the stepped surface of the first end of the inner race.

5. The wheel bearing assembly of claim 1, wherein the inner race comprises two pieces that together form the center portion extending between the first end and the second end.

6. The wheel bearing assembly of claim 5, wherein each of the two pieces comprises a stepped surface configured to interlock with the stepped surface of the other of the two pieces.

7. The wheel bearing assembly of claim 1, further comprising a seal positioned on an inner surface of the inner race, wherein the seal is configured to seal with a shaft when the shaft extends through wheel bearing assembly.

8. The wheel bearing assembly of claim 1, further comprising a pinch nut configured to create and maintain a desired preload on the wheel bearing assembly.

9. A wheel bearing assembly, comprising:
an outer race having a first angled inner surface and a second angled inner surface, wherein the first angled inner surface and the second angled inner surface form a peak;
a first roller bearing positioned within the outer race, the first roller bearing having a plurality of rollers configured to engage with the first angled inner surface of the outer race;
a second roller bearing positioned within the outer race adjacent the first roller bearing, the second roller bearing having a plurality of rollers configured to engage with the second angled inner surface of the outer race;
a first shield configured to engage with an outer edge of the first roller bearing and push the first roller bearing against the first angled inner surface of the outer race, the first shield comprising a rubber seal configured to reduce passage of fluid into or out of the first roller bearing; and
a second shield configured to engage with an outer edge of the second roller bearing and push the second roller bearing against the second angled inner surface of the outer race, the second shield comprising a rubber seal configured to reduce passage of fluid into or out of the second roller bearing.

10. The wheel bearing assembly of claim 9, wherein the seal of the first shield and the seal of the second shield each contact the outer race.

11. The wheel bearing assembly of claim 9, further comprising an inner race positioned within the outer race such that the first roller bearing and the second roller bearing are each positioned between the inner race and the outer race.

12. The wheel bearing assembly of claim 11, wherein the inner race comprises two pieces.

13. The wheel bearing assembly of claim 12, wherein each of the two pieces comprises a stepped surface configured to interlock with the stepped surface of the other of the two pieces.

14. The wheel bearing assembly of claim 11, the inner race having a center portion extending between a first end and a second end, wherein the first end and the second end each have a stepped surface with a first inner diameter and the center portion has a second inner diameter, wherein the first inner diameter is greater than the second inner diameter.

15. The wheel bearing assembly of claim 14, the first shield further comprising a guiding lip configured to engage with the stepped surface of the first end of the inner race.

16. The wheel bearing assembly of claim 11, further comprising a seal positioned on an inner surface of the inner race, wherein the seal is configured to seal with a shaft when the shaft extends through wheel bearing assembly.

17. The wheel bearing assembly of claim 9, further comprising a nut configured to create and maintain a desired preload on the wheel bearing assembly.

18. A wheel bearing assembly, comprising:
a race having a first surface and a second surface;
a first roller bearing having a plurality of rollers configured to engage with the first surface of the race;
a second roller bearing having a plurality of rollers configured to engage with the second surface of the race;
a first shield configured to engage with an edge of the first roller bearing and push the first roller bearing against the first surface of the race, the first shield comprising a seal configured to reduce passage of fluid into or out of the first roller bearing; and
a second shield configured to engage with an edge of the second roller bearing and push the second roller bearing against the second surface of the race, the second shield comprising a seal configured to reduce passage of fluid into or out of the second roller bearing.

19. The wheel bearing assembly of claim 18, wherein the seal of the first shield and the seal of the second shield each contact the race.

20. The wheel bearing assembly of claim 18, wherein the seal of the first shield and the seal of the second shield each comprises a rubber material or a steel material.

21. The wheel bearing assembly of claim 18, wherein the race is an outer race and the wheel bearing assembly further comprises an inner race positioned within the outer race such that the first roller bearing and the second roller bearing are each positioned between the inner race and the outer race.

22. The wheel bearing assembly of claim 21, wherein the inner race comprises two pieces.

23. The wheel bearing assembly of claim 22, wherein each of the two pieces comprises a stepped surface configured to interlock with the stepped surface of the other of the two pieces.

24. The wheel bearing assembly of claim 21, the inner race having a center portion extending between a first end and a second end, wherein the first end and the second end each have a stepped surface with a first inner diameter and the center portion has a second inner diameter, wherein the first inner diameter is greater than the second inner diameter.

25. The wheel bearing assembly of claim 24, the first shield further comprising a guiding lip configured to engage with the stepped surface of the first end of the inner race.

26. The wheel bearing assembly of claim 21, further comprising a seal positioned on an inner surface of the inner race, wherein the seal is configured to seal with a shaft when the shaft extends through wheel bearing assembly.

27. The wheel bearing assembly of claim 18, further comprising a nut configured to create and maintain a desired preload on the wheel bearing assembly.
